(19) United States
(12) Patent Application Publication
(10) Pub. No.: US 2026/0330111 A1
(43) Pub. Date: Oct. 22, 2026

(54) CLOUD-BASED SEMICONDUCTOR DESIGN TOOL

(71) Applicant: ChipInventor Semiconductor Systems Inc., Dover, DE (US)

(72) Inventors: Dario Sassi Thober, Campinas (BR); Rafael Vidal Aroca, São Carlos (BR); Matheus Santos Souza, Limeira (BR); Augusto Almeida de Jesus, São Carlos (BR); André Luis Roland Tancredo, Limeira (BR); Daniel Marcos Souza do Couto, São Carlos (BR); Natalia Pereira Almeida Ferreira, Belo Horizonte (BR); Igor Saiti Ogawa, São Paulo (BR)

(21) Appl. No.: 19/641,042

(22) Filed: Apr. 7, 2026

Related U.S. Application Data
(60) Provisional application No. 63/785,349, filed on Apr. 8, 2025.

(51) Int. Cl. G06F 30/31; G06F 8/34; G06F 9/451; G06F 30/3308; G06Q 30/0601; G06Q 50/18

(52) U.S. Cl. CPC G06F 30/31; G06F 8/34; G06F 30/3308; G06Q 30/0609; G06Q 50/184; G06F 9/451

(57) ABSTRACT

A cloud-based semiconductor design tool provides multiple interactive graphical user interfaces (GUIs) for designing, synthesizing, simulating, and prototyping semiconductor circuits in digital and/or analog domains. A user submits one or more semiconductor blocks via a first GUI, each of which is stored as a data structure in a library, including a hardware description language (HDL) representation or an electronic schematic with defined inputs and outputs. Using a second GUI, the user creates a circuit design by electrically coupling the blocks through drag-and-drop, a code editor, or both. A third GUI enables simulation of the circuit design, including dynamic and waveform simulations, with results displayed via a fourth GUI. For digital designs, the tool supports programming a physical hardware device through an interactive programming interface for prototyping. The system further includes an IP marketplace supporting analog and digital design components.

### CROSS-REFERENCE TO RELATED APPLICATIONS

This application claims priority from and is related to U.S. Provisional Application No. 63/785,349, entitled “CLOUD-BASED SEMICONDUCTOR DESIGN TOOL,” filed Apr. 8, 2025, which is hereby incorporated into the present application by reference in its entirety.

### FIELD OF THE DISCLOSURE

The present disclosure generally relates to semiconductor design and, more particularly, to semiconductor design software.

### BACKGROUND

Traditional Electronic Design Automation (EDA) tools have long been a critical component of the semiconductor and electronics design industries, enabling the creation of complex integrated circuits (ICs) and electronic systems. However, despite their capabilities, these tools present several challenges that can hinder innovation, increase costs, and limit design flexibility.

One major issue with traditional EDA tools is vendor lock-in. Once a design team adopts a specific tool, their project files, workflows, and design methodologies often become tightly integrated with that ecosystem. This dependency creates a significant barrier to switching tools or providers, as design files may not be fully compatible with other EDA platforms. If a company decides to discontinue a license or if the vendor changes its pricing model, access to critical design files and project data may be lost, creating substantial operational and financial risks. This lack of independence and freedom can stifle agility, particularly for startups or smaller design teams that need flexibility in their toolsets.

Cost is another critical challenge. Traditional EDA tools are notoriously expensive, with licensing fees per user, per tool, per year. Many companies negotiate multi-million-dollar package deals to access a suite of EDA tools, a cost that only large corporations can typically absorb. For smaller firms or individual designers, these costs can be prohibitive, potentially pushing them toward less robust or less efficient design methodologies. High licensing costs also reduce the ability to experiment with new tools or workflows, as each shift in technology could represent a substantial financial commitment.

Additionally, traditional EDA tools often struggle to keep pace with the evolving demands of modern design processes, particularly with the rise of machine learning, advanced simulations, and increasingly complex IC architectures. Many legacy tools were not designed with these emerging technologies in mind, resulting in inefficiencies or the need for costly add-ons. This gap between tool capabilities and industry needs can limit innovation and delay product development cycles.

### SUMMARY OF THE INVENTION

One aspect of the current invention is a cloud-based semiconductor design tool. The method begins by receiving, from at least one user, via a first interactive web-based graphical user interface (GUI), a design for one or more logic blocks. Each logic block is formed as a corresponding data structure that holds a collection of features specific to that logic block, including a hardware description language (HDL) such as Verilog code, with defined inputs and outputs. These logic blocks are then stored in a library.

Next, the system receives, from the user, via a second interactive GUI, a composite digital design to be synthesized. This composite digital design involves electrically coupling the inputs and outputs of two or more logic blocks from the library to create the composite digital design, as defined in the corresponding data structures. The user can perform this synthesis by either dragging and dropping the logic blocks from the library, using a textual code editor, or a combination of both methods.

The system also involves receiving, from the user, via a third interactive GUI, a request to perform a simulation on the composite digital design using the corresponding data structure. The simulation can be dynamic, waveform-based, or a combination of both. The results of this simulation are presented to the user via a fourth interactive GUI.

In addition, the system includes receiving, from the user via a fourth interactive GUI, a request to program a physical hardware device using the corresponding data structure from the composite digital design via an interactive graphical user interface.

The HDL used in the design can be any of several languages, including Verilog, VHDL, SystemVerilog, or SystemC. Furthermore, the design process can incorporate a generative artificial intelligence (AI) module to assist in generating at least a portion of the logic block. This generative AI can be prompted to create or enhance the design, thereby automating portions of the design process.

For the simulation, the method also includes the option to perform field-programmable gate array (FPGA) or silicon synthesis, depending on the design's specific needs. Additionally, the user can request that a process design kit (PDK) based on the composite digital design be sent to one or more foundries for manufacturing.

The system also allows for physical verification of the silicon synthesis, enabling the user to request a 3D graphic data system representation of the digital design. Finally, the method facilitates cloud-based collaboration, allowing multiple users to interact simultaneously with graphical user interfaces (GUIs) at different stages of the design, simulation, and programming processes. This collaborative environment supports the efficient and flexible development of semiconductor designs.

Also disclosed is a computer-implemented method for analog circuit design. The method begins by receiving, from at least one user via a first cloud-based interactive graphical user interface (GUI), a design for one or more analog blocks. Each of these analog blocks is represented as a data structure that encapsulates a set of features specific to that block. These features use a process design kit (PDK) with defined components, each one with inputs and outputs. The analog blocks are stored in a library of logic blocks for reuse and integration in circuit design.

Next, the method involves receiving, via a second interactive GUI, an analog component to be connected by electrically coupling inputs and outputs from two or more components within the library. This process is accomplished by retrieving the selected components and arranging them using a drag-and-drop functionality. The defined data structures ensure proper connectivity and compatibility between the components, facilitating the creation of an analog design.

Following the schematic synthesis, the method provides a simulation phase, in which the user interacts with a third GUI to simulate the schematic design. This is achieved using a schematic simulation module that integrates simulation tools and data formats, enabling verification of circuit behavior. Additionally, the method includes modeling a fabrication process using the PDK within an analog designer module. The PDK comprises files that enable the modeling of the fabrication process for semiconductor industry design tools.

The software container utilized in this method further comprises at least one of a container name, a description of the container role, a description of a microservice, an analog designer, software code, an external system name, or a combination thereof. Within the schematic simulation module, at least one of the following may be included to facilitate simulation and visualization of the design: an SPICE model, JavaScript Object Notation (JSON), topology logs, or graphics.

During schematic synthesis, the analog design process incorporates defining an overall circuit architecture based on design specifications in the conceptual design phase of an analog chip design flow. These design specifications include functional components, circuit topologies, and key performance metrics such as gain, bandwidth, power consumption, or noise characteristics.

The method also encompasses the high-level design and optimization of individual circuit elements during the component creation phase of the analog chip design flow. These circuit elements may include amplifiers, current mirrors, voltage references, or oscillators. Once the schematic is finalized, the method further validates the detailed circuit diagrams by simulating them with SPICE or other circuit simulation tools. These simulations account for variations in temperature and fabrication processes, ensuring robust performance under different conditions.

To enhance simulation accuracy, the method includes creating verification environments, hereinafter referred to as testbenches, that simulate real-world operating conditions. These testbenches evaluate key parameters such as gain, phase margin, and power dissipation to verify circuit performance and reliability.

Once the circuit design is validated, the method extends to the physical implementation phase. This involves arranging transistors, resistors, capacitors, and interconnects during the layout phase while adhering to manufacturability and reliability design rules. Following layout completion, parasitic extraction is performed to account for real-world effects, such as mismatches, parasitic capacitance, and resistance. A post-layout simulation is then conducted to ensure that the circuit functions as expected despite the inclusion of parasitic elements.

By integrating schematic design, simulation, and physical implementation within a comprehensive software framework, this method streamlines the analog circuit design process, improving efficiency, accuracy, and manufacturability.

In another example, the present invention provides an online marketplace that connects analog and digital semiconductor designers with potential buyers, involving several key steps. First, a seller submits a registration request that includes their credentials and intellectual property (IP) information. The system then verifies the seller's legal rights to sell or license the IP based on the provided credentials. Upon successful verification, a seller account is created, allowing the seller to list their IP on the marketplace platform. Buyers can then submit search requests with specific criteria related to the IP they seek. The platform displays matching IP listings to buyers and facilitates communication between buyers and sellers via a secure messaging channel. To streamline transactions, an online contract is generated to automate royalty payments and ensure transparency. Additionally, funds are held in escrow until the buyer confirms receipt and verification of the IP, providing security for both parties.

Other features and advantages of the invention will become apparent to those skilled in the art upon review of the following detailed description, claims, and drawings.

### BRIEF DESCRIPTION OF THE DRAWINGS

The accompanying figures, where like reference numerals refer to identical or functionally similar elements throughout the separate views, and which together with the detailed description below are incorporated in and form part of the specification, serve to illustrate various embodiments further and to explain various principles and advantages all in accordance with the present disclosure, in which:

FIG. 1 depicts a high-level diagram of Software as a Service (SaaS) with a client console interaction with a cloud service provider, according to the prior art;

FIG. 2 depicts a high-level diagram of various aspects of the ChipInventor system, according to one example of the present invention;

FIG. 3 depicts a high-level diagram of an interactive graphical interface of reusable blocks that are offered through an online marketplace, according to one example of the present invention;

FIG. 4A through FIG. 4D is a diagram of a digital design flow using the ChipInventor system, according to one example of the present invention;

FIG. 5 depicts a high-level diagram of an interactive graphical interface for designing a block in circuit design, according to one example of the present invention;

FIG. 6 depicts a high-level flow diagram for designing an analog circuit, according to one example of the present invention;

FIG. 7A through FIG. 7C is a diagram of an analog design flow using the ChipInventor system, according to one example of the present invention; and

FIG. 8 depicts a high-level diagram of an IP Marketplace, according to one example of the present invention; and

FIG. 9 illustrates an example information processing system for carrying out the aspects of FIG. 1 through FIG. 8 above, according to one aspect of the present invention.

### DETAILED DESCRIPTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting but merely as a basis for the claims and as a representative basis for teaching one skilled in the art to variously employ the disclosed subject matter in virtually any appropriately detailed structure and function. Further, the terms and phrases used herein are not intended to be limiting but rather to provide an understandable description.

### Non-Limiting Definitions

The terms “a” or “an”, as used herein, are defined as one or more than one. The term plurality, as used herein, is defined as two or more than two.

The term “adapted to” describes the hardware, Software, or a combination of hardware and Software that is capable of, able to accommodate, to make, or that is suitable to carry out a given function.

The term “another”, as used herein, is defined as at least a second or more.

The term “block” refers to a self-contained module or subsystem that performs a specific function within a larger system. Blocks are used to design complex circuits in a hierarchical manner, making it easier to manage, design, and debug digital systems.

The term “configured to” describes hardware, Software, or a combination of hardware and Software that is adapted to, set up, arranged, built, composed, constructed, designed, or that has any combination of these characteristics to carry out a given function.

The term “coupled,” as used herein, is defined as “connected,” although not necessarily directly, and not necessarily mechanically.

The terms “including” and “having,” as used herein, are defined as comprising (i.e., open language).

The term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

The term “software container” is a lightweight, portable, and self-sufficient environment that encapsulates an application and its dependencies, ensuring consistency across different computing environments.

It should be understood that the steps of the methods set forth herein are not necessarily required to be performed in the order described, and the order of the steps of such methods should be understood to be merely exemplary. Likewise, additional steps may be included in such methods, and certain steps may be omitted or combined in methods consistent with various embodiments of the present device.

### Overview

The steps of any methods disclosed herein do not have to be performed in the exact order disclosed unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments and vice versa.

One commercial aspect of the present invention is offered under the brand name “ChipInventor,” available at an online uniform resource locator (URL) with the same name. ChipInventor transforms the way semiconductor chips are designed by significantly boosting the productivity of specialized engineers and expanding access to design for a broader range of users. The ChipInventor EDA Platform offers a comprehensive suite of well-integrated tools within a user-friendly semiconductor development environment, enabling quick design, prototyping, simulation, and fabrication. Unlike traditional EDA design companies, ChipInventor excels in productivity and time-to-market by seamlessly integrating complex processes—from block design and simulation to FPGA testing and layout synthesis for fabrication—into a single, intelligently guided online workflow. The platform's proprietary multi-FPGA-based testing and synthesis technology, along with its native RISC-V environment for core design and programming, enhances versatility and efficiency. ChipInventor democratizes chip design by allowing virtually all engineers, not just highly specialized experts, to participate in the process. With advanced features such as an AI assistant, automated testbench generation, shortcuts for visual block generation, and tools for creating custom AI chips, ASICs, and accelerators, ChipInventor empowers users to accelerate prototyping and fabrication cycles, driving innovation and market expansion.

### SaaS Architecture

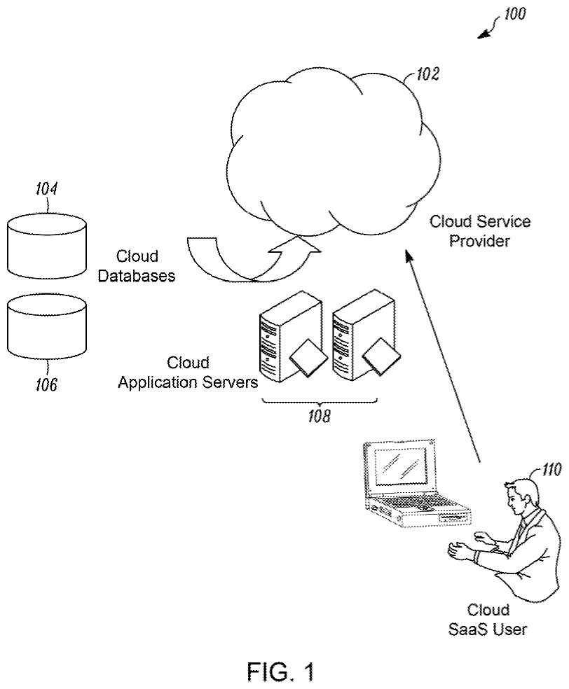

FIG. 1 depicts a high-level diagram of SaaS 100 of a client console 110 interaction with a cloud service provider 102. Shown are one or more cloud application servers 108 that run the ChipInventor system. Cloud databases are communicatively coupled to the cloud application servers 104, 108.

### ChipInventor System Components

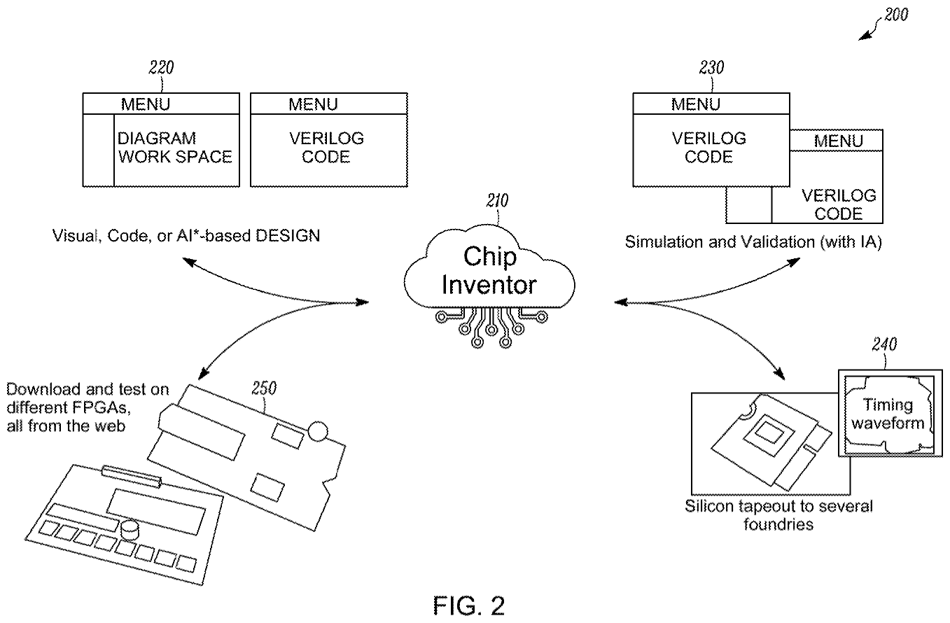

FIG. 2 depicts a high-level diagram 200 of various aspects of the ChipInventor system 210. The system integrates various features of chip design. Shown is the block and circuit design component 220. A simulation and validation component with artificial intelligence (AI). A hardware test component 250.

In one example, the hardware test component 250 is the ChipInventor DevBoard (development board). The ChipInventor DevBoard is a comprehensive platform that provides a complete learning and project-validation environment for FPGA and semiconductor design. One example is the DevBoard, which is affordable and well-documented, offering 8,640 logic units to accommodate small to medium projects with ease. Another number of logic units in other examples is also possible. The ChipInventor DevBoard features pre-made connections and support circuitry for a wide array of popular sensors and peripherals, making it an ideal choice for learners and developers alike. Whether you're a beginner exploring FPGA technology or an experienced designer working on advanced semiconductor projects, the ChipInventor DevBoard delivers the tools and resources you need to bring your ideas to life. Details on the ChipInventor DevBoard are described in Brazilian Patent Application No. BR 10 2024-015484-3, filed on Jul. 29, 2024, entitled “Data Transfer System and Method For Reconfigurable Electronic Equipment,” with assignee ChipInventor Semiconductors, LTDA, and listing the first-named inventor, Rafael Vidal Aroca, is hereby incorporated by reference in its entirety. Also shown is a silicon tape out to several foundries, including a timing waveform 240.

### Reusable Blocks Offered Through an IP Marketplace

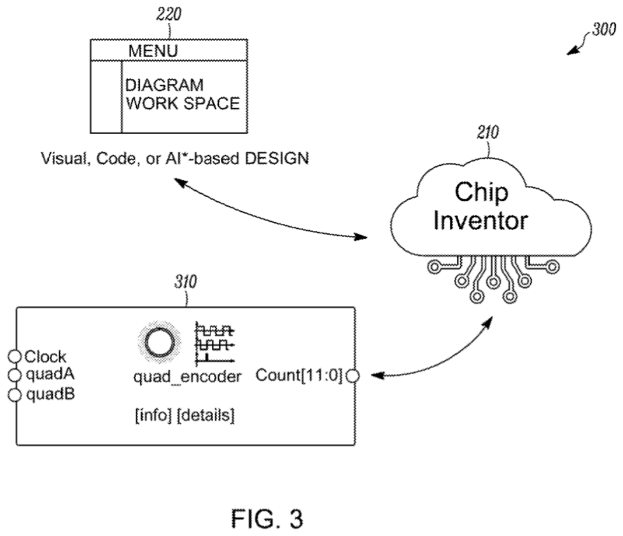

FIG. 3 depicts a high-level diagram 300 of an interactive graphical interface for reusable blocks offered through an online marketplace. As described further below, a block designer using the ChipInventor system 210 may share a block design 310. The block design in this example is a quad_encoder, and other blocks may be used. The block can be designed 320 using visual interactive drag and drop tools. Artificial Intelligence (AI) tools can assist in creating the block, or other tools may be used. The IP Marketplace allows the block owner to license or sell the use of their design. The license may include terms such as exclusivity, a geographic territory, a field of use, and more. The license may be free or royalty-based. Payments and contracts may all be implemented online without human involvement. Examples of online contract technology include clickwrap agreements, browserwrap agreements, e-signed agreements, and smart contracts.

### Blocks Designer

The use of block design 310 of FIG. 3 provides modularity by making complex designs more manageable. The block designer can create their own design or reuse one from a library. They can be reused across multiple projects and facilitate scalability by allowing seamless integration of multiple blocks. Moreover, the use of blocks simplifies debugging by isolating issues within specific functional units.

In hardware description languages (HDLs) such as Verilog or VHDL, blocks are often represented as modules or entities, which can be instantiated multiple times within a design.

Types of blocks in digital circuit design include combinational blocks—These blocks operate purely based on the inputs and do not have memory. Examples of combinational blocks include adders, multiplexers, encoders/decoders, and logic gates.

Sequential Blocks—These blocks use memory elements (like flip-flops or registers) and have state-dependent behavior. Examples of sequential blocks include counters, shift registers, Finite State Machines (FSMs),

Functional Blocks—Higher-level blocks that implement specific digital functions. Examples of functional blocks include an Arithmetic Logic Unit (ALU), a memory controller, and Digital Signal Processing (DSP) block(s).

IP (Intellectual Property) Blocks—Pre-designed, reusable blocks provided by vendors for FPGA or ASIC design, such as PCIe controllers, USB interfaces, CPU/processor cores, networking physical layers, protocol implementations, and cryptographic engines, among others.

### Digital Design Flow

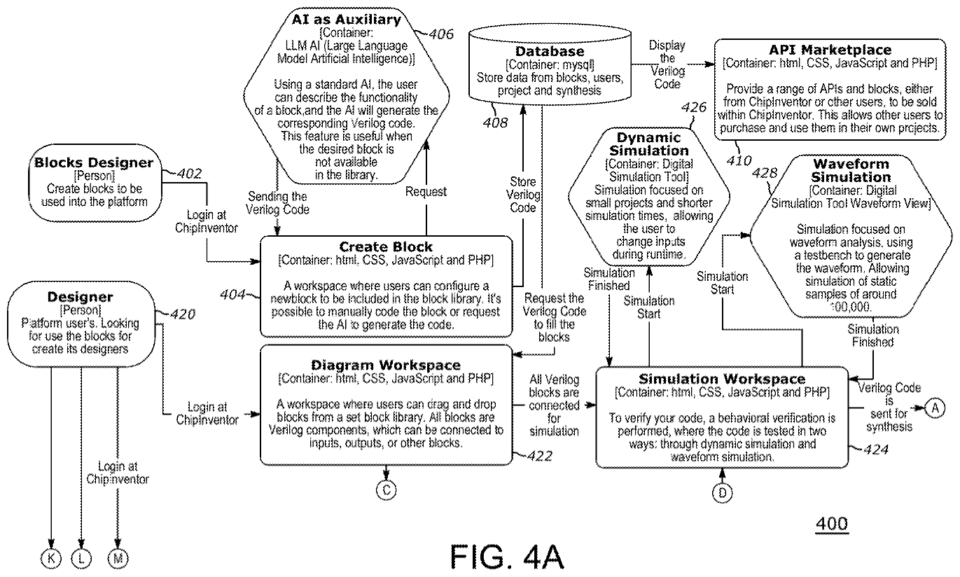

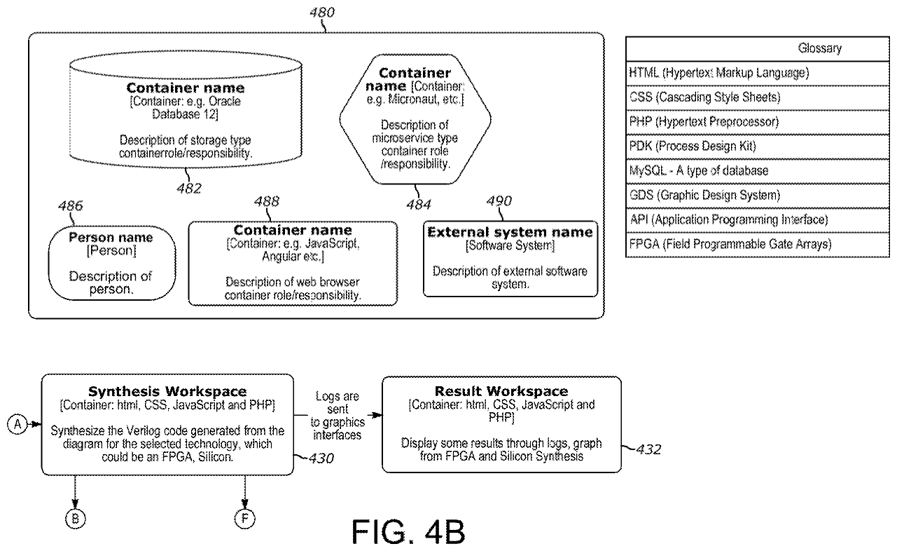

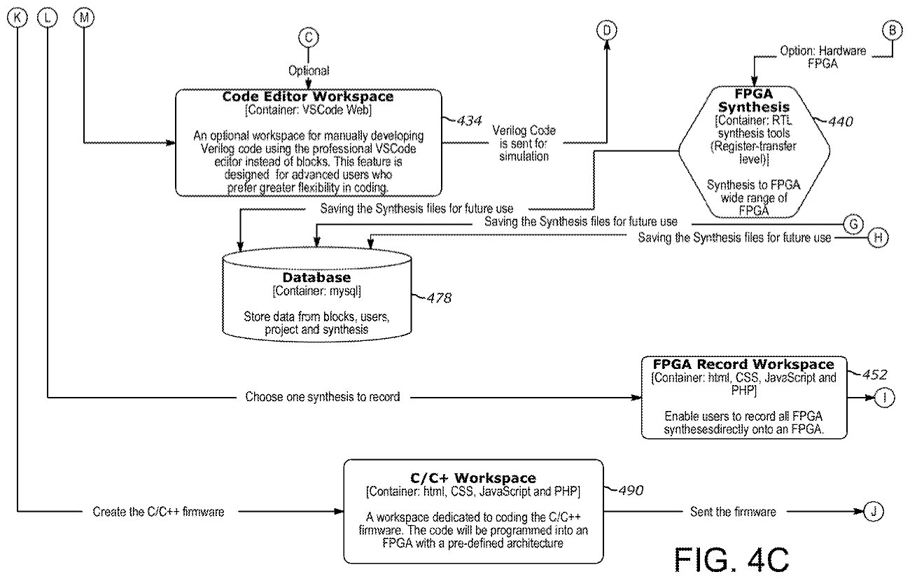

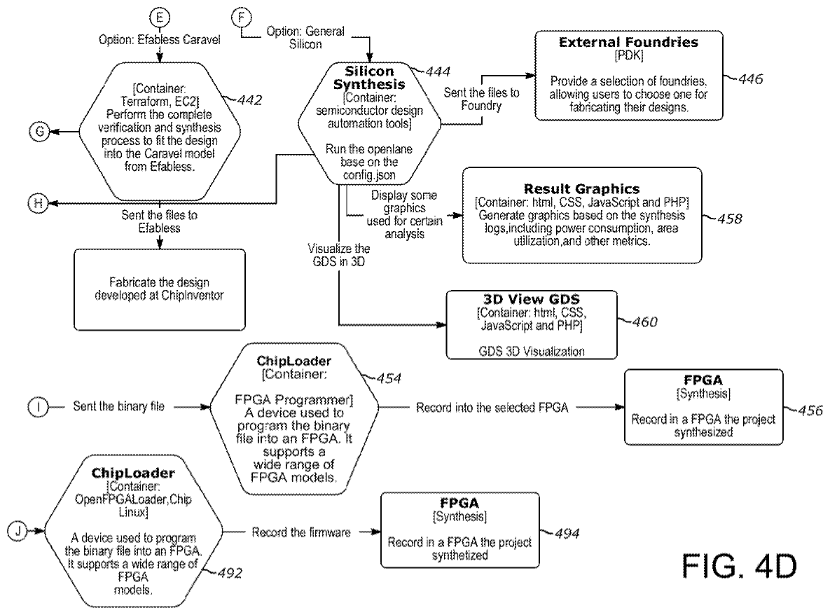

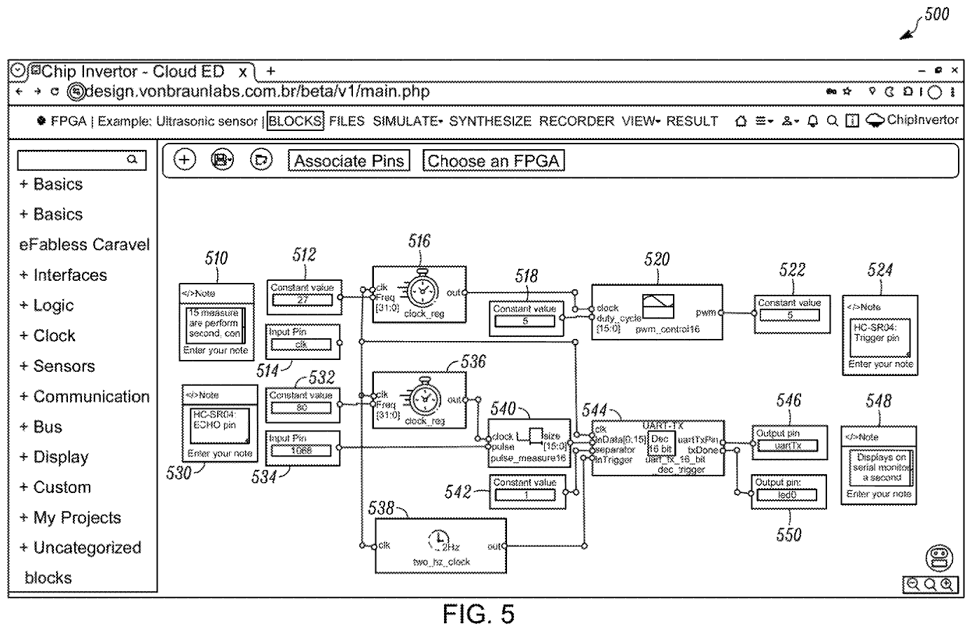

FIG. 4A through FIG. 4D is a diagram 400 of a digital design flow using the ChipInventor system. A person, e.g., a block designer, creates blocks for the ChipInventor system 210. See block designer module 402. Once the block designer is logged on to the ChipInventor system 210, the block designer can create a block 404 represented as a self-executing software container or software structure. In this example, the container includes client-side code, such as HTML, CSS, JavaScript, and a server-side hypertext preprocessor (PHP). The PHP influenced the client-side code. The block 404 may be created using code, such as Verilog code, or through a graphical user interface, such as that shown in FIG. 5, with or without the assistance of an AI module 406.

Using the AI module 406, the user can describe a block's 404 functionality, and the AI module 406 will generate the corresponding Verilog code. This feature is useful when the desired block 404 is not available in the database 408 or library. In one example, the blocks are stored in Verilog code, but other representations are possible.

An Application Programming Interface (API) for an IP Marketplace 410 is also provided. The IP Marketplace provides a range of APIs and blocks, either from the ChipInventor system 210 or other users, to be licensed or sold within ChipInventor. This allows other users to purchase and use them in their own projects.

A person, i.e., a designer 420 (in one embodiment 402 and 404 are the same person or they can be different people) uses multiple blocks from database 408 to create more complex circuits in a diagram workspace module 422. See designer block 420. The diagram workspace module 422 provides an interactive graphical user interface as shown in FIG. 5. The designer 420 can drag and drop blocks from a set block library. In one example, blocks are Verilog components, which can be connected to inputs, outputs, or other blocks. The blocks are represented by a software container 480, as shown in FIG. 4B and arranged and dragged and dropped into place through an interactive user interface, as shown in FIG. 5.

The software container 480, as shown in FIG. 4B is used as part of the create block module 404 as well as other modules. The software container 480 may include a container name 482 and a description of the container's role/responsibility 482. The software container 480 may include a description of a microservice 484. The software container 480 may include a name 486 of a digital designer who is creating or using the software container. The database of software containers 780 may further include code, such as, JavaScript, Angular, and C #. An external system name 488 may also be included in the software container 480.

The diagram workspace module 422, in an optional embodiment, may be replaced by or used with the code editor workspace module 434. The code edit workspace includes operations for creating, saving, and editing new files, as well as changing synthesis parameters. The code editor workspace module 434 is for manually developing Verilog code using a professional code editor instead of blocks from 404 and 408. This feature is designed for advanced users who prefer greater flexibility in code. Regardless of whether the code editor workspace module 434 is used with or without the diagram workspace module 422, the results are stored in a project database. Note that the project database can be the same database as database 408 or separate.

Once the circuit is designed, the process typically flows to a simulation workspace module 424. The simulation workspace verifies the design. Verification is performed by testing the code in two ways: through the dynamic simulation module 426 and the waveform simulation module 428. The dynamic simulation is typically a simulation focused on small projects and shorter simulation times. This allows the designer to change or modify inputs during runtime.

The waveform simulation module 428 is generally used for waveform analysis, and a testbench is used to generate the waveform. Allowing simulation of static samples of around 100,000 iterations.

After the simulation workspace module 424, the process typically flows to the synthesis workspace module 430 in FIG. 4B. The synthesis workspace module 430 synthesizes the Verilog code generated from the diagram for the selected technology. In one example, the selected technology is FPGA synthesis module 440, as shown in FIG. 4C. As shown in FIG. 4D, Silicon Synthesis module 444 is deployed in semiconductor design automation tools. The resulting synthesis can be sent to an external foundry module 446 and documented in the result graphics module 458. Also, a 3D view module 460 of the chip may be visualized. Further, a results workspace module 432 captures the results of the synthesis workspace module 430, along with other results, which may be documented through logs, graphs, and charts from FPGA and Silicon Synthesis.

In cases where the architecture implemented on the FPGA requires firmware—such as CPUs, GPUs, or similar designs—the designer 420 may use the C/C++ Workspace 490. This workspace is dedicated to coding and compiling C/C++ code, typically used for firmware development. The resulting code is then available to be programmed into a memory accessible for FPGA's predefined architecture. A first chiploader module 492 in FIG. 4D is a device used to program either the bitstream file into the FPGA or a binary file into memory accessible to the FPGA, when required by the FPGA's predefined architecture. It supports a wide range of FPGA models to send a record in an FPGA project that is a synthesis module 494.

An FPGA Record workspace module 452 of FIG. 4C enables users to record all FPGA synthesis directly onto the FPGA. The process flows to second chiploader module 454 of FIG. 4D. The second chiploader module 454 is a device used to program the bitstream file into an FPGA. It supports a wide range of FPGA models to send a record in an FPGA project that is a synthesis module 456.

### Interactive Circuit Design

FIG. 5 depicts a high-level diagram of an interactive graphical interface 500 for designing a block in circuit design, such as the diagram workspace module 422 of FIG. 4. In this example, an interface for an ultrasonic circuit design is shown, composed of several blocks. This diagram workspace module 422 is not limited to ultrasonic circuits; it supports a wide variety of circuit designs. Shown are a pair of notes 510 and 530, corresponding to input pin values 514 and 534, and constant values 512 and 532. The input pin value 514 and the constant value 512 are inputs to a first clock register 516. The input pin value 534, and the constant value 532 are inputs to a second clock register 536.

The output of the first clock register 516 is electrically coupled to the first input of pulse width modulator (PWM) 520. A second constant value 518 is a second input to PWM 520. An output of the PWM 520 is electrically coupled to output 522. Memo or note 524 documents the purpose of this pin.

The output of the second clock register 536 is electrically coupled to the first input of pulse measurement 540. The input pin value 534 is a second input to pulse measurement 540. An output of the pulse measurement 540 and a constant value 542 are coupled to the inputs of a universal asynchronous receiver-transmitter (UART) 544. A first output pin of the UART 544 is electrically coupled to an output transmit pin (TX) 546. A second output of the UART 544 is output pin 550 when TX is completed. A memo or note 548 documents the purpose of the output transmit (TX) pin 546 and the output pin 550.

### Analog Design Flow

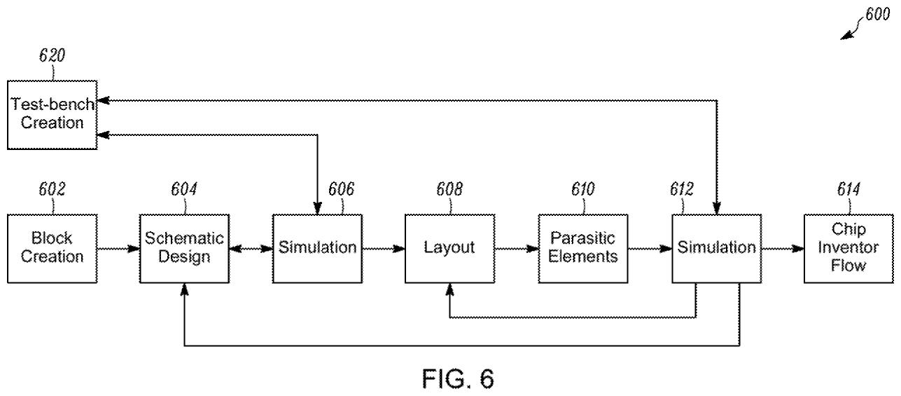

FIG. 6 depicts a high-level analog chip design flow diagram 600. The analog chip design flow 600 is a structured process that ensures a circuit meets performance, power, and area requirements before fabrication. It begins with the conceptual design phase, where engineers define the overall circuit architecture based on design specifications. This phase involves identifying functional blocks, selecting appropriate circuit topologies, and determining key performance metrics such as gain, bandwidth, power consumption, and noise characteristics. Once the architecture is established, designers proceed with block creation 602, where individual circuit elements—such as amplifiers, current mirrors, voltage references, and oscillators—are designed and optimized at a high level.

Next, the schematic design phase 604 involves creating detailed circuit diagrams using EDA tools. Engineers define transistor-level implementations and establish interconnections between components. This schematic is then validated through simulation 606, where SPICE model or other circuit simulation tools analyze the performance of the design under various conditions, including temperature variations and process variations. To ensure robustness, engineers create testbenches 620 to simulate real-world operating conditions and evaluate key parameters like gain, phase margin, and power dissipation.

Once the schematic is verified, the design moves to the layout phase 608, where the circuit is physically implemented on silicon. This step involves arranging transistors, resistors, capacitors, and interconnects while adhering to design rules that ensure manufacturability and reliability. During this phase, engineers also focus on minimizing layout-dependent effects such as mismatches, parasitic capacitance, and resistance. After the layout is completed, parasitic extraction 610 is performed to account for real-world effects that may impact circuit behavior. The extracted circuit undergoes another round of post-layout simulation 612, ensuring that the circuit performs as expected despite added parasitic elements. The output goes to ChipInventor flow 614. Note that ChipInventor flow 614 is not a final step, as shown in FIG. 6, but it is the representation of every item on that diagram flow: design, schematics, layout, simulation-all these together make up ChipInventor flow 614. Other steps include Layout versus Schematic (LVS), Design Rule Check (DRC), and antenna design check.

We can group all of these into “Verification” or add each one individually.

The final steps may include design verification (not shown) and sign-off checks (not shown), where engineers conduct extensive simulations and checks, such as DRC and LVS verification, to confirm that the layout accurately represents the schematic. Once the design passes all verification stages, it is sent for fabrication. After manufacturing, the first batch of chips undergoes silicon validation and testing to ensure they perform according to design specifications. If necessary, design modifications are made, and the process iterates until the chip is production-ready. This meticulous approach ensures that analog circuits function correctly and reliably in real-world applications.

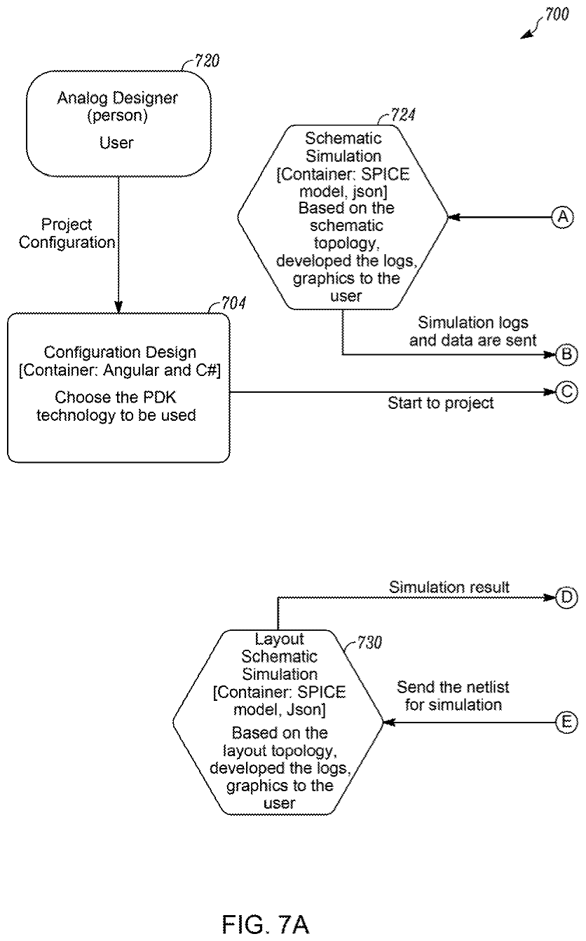

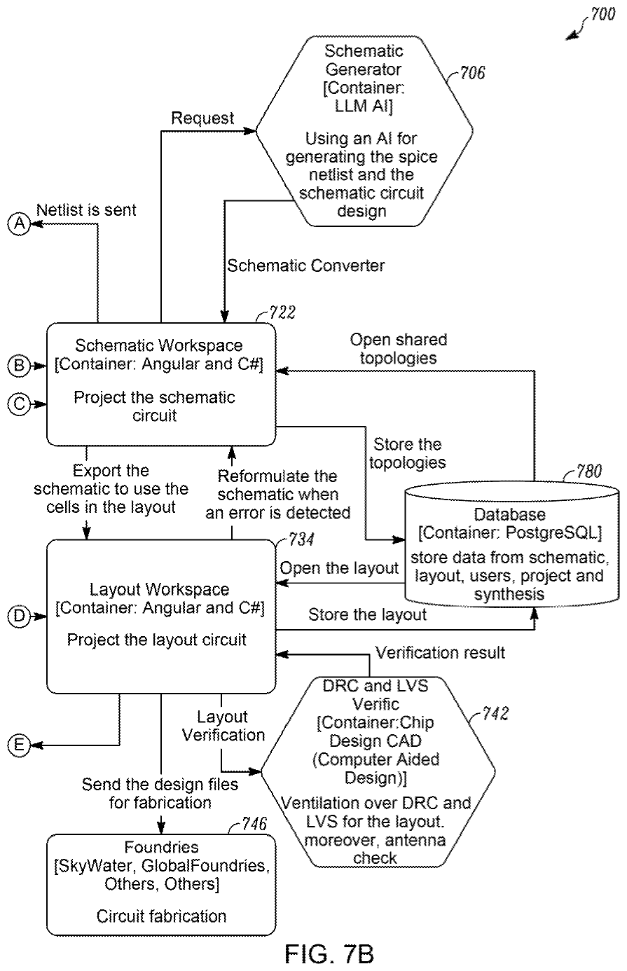

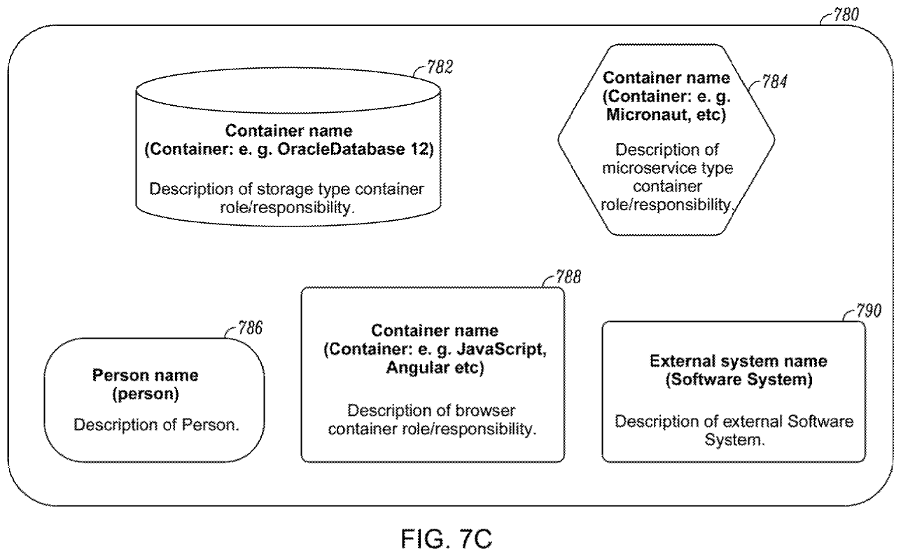

FIG. 7A through FIG. 7C is a diagram of an analog design flow 700 using the ChipInventor system 210. After logging on to the ChipInventor system 210, a user, i.e., an analog designer, would begin a project configuration and design module 704. See the analog designer module 720. The configuration and the design module 704 may include a process design kit (PDK). The PDK is a set of files used within the semiconductor industry to model a fabrication process for the design tools used to design an integrated circuit. The PDK are typically used by the foundry to define a certain technology variation for their processes.

A database of software containers 780 is used as part of the configuration, as shown in FIG. 7C. The software container 780 may include a container name along with a description of the container role/responsibility 782. The software container 780 may include a description of a microservice 784. The database of software containers 780 may include the analog designer 786 who is creating or using the container. The database of software containers 780 may further include code, such as JavaScript, Angular, and C #. The external system name (similar to 488) may also be included in the database of software containers 780.

Returning to FIG. 7B, a schematic workspace module 722 using the database of software containers 780 is used. This analog schematic workspace is similar to the diagram workspace module 422 for the digital design in FIG. 4A as described above. A schematic simulation module 724 is also used as part of the schematic workspace module 722. The schematic simulation module 724 may include SPICE models, JSON, and topology logs and graphics for the designer. A netlist may be sent from the schematic workspace module 722 to the schematic simulation module 724 as shown. A schematic generator module 706 is coupled to the schematic workspace module 722. The schematic generator may include an AI module to help with the schematic design before converting it back into a software container to be used by the schematic workspace module 722.

The database of software containers 780 is used to store and retrieve data from the schematic workspace module 722 and layout workspace module 734. The layout workspace module 734 interfaces with a layout schematic simulation module 730, as shown.

The layout workspace module 734 also interfaces with a DRC and LVS module 742. The LVS module 742 is a critical step in integrated circuit (IC) design that verifies whether the physical layout of a chip matches the intended schematic or circuit diagram. It ensures that the final product functions as intended by comparing the layout netlist with the schematic netlist.

The final product is then sent to foundries 746, such as SkyWater, GlobalFoundries, or others, for semiconductor circuit fabrication.

### IP Marketplace

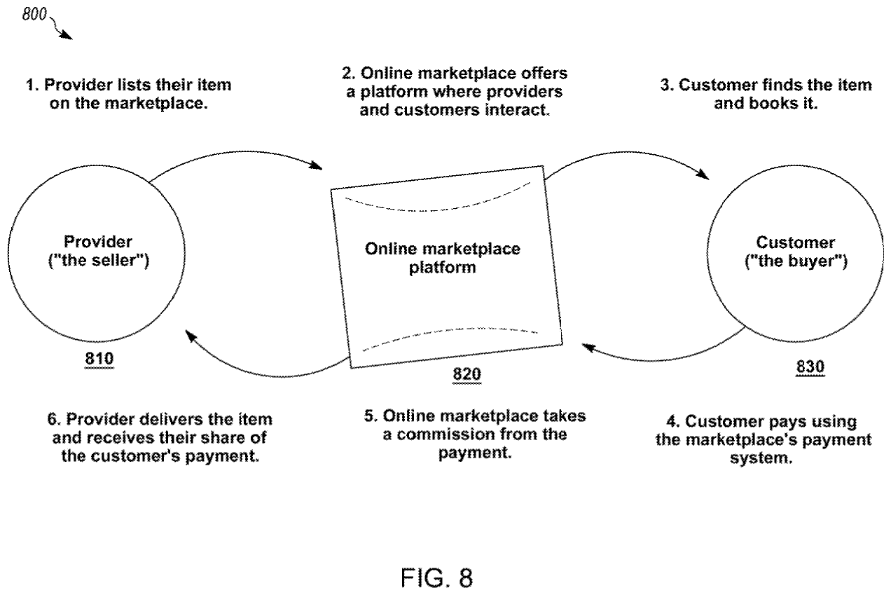

FIG. 8 depicts a high-level diagram 800 of an online IP Marketplace. The online marketplace for selling or licensing chip designs would serve as a centralized platform where semiconductor designers can connect with potential buyers, streamlining the transaction process for intellectual property (IP) related to integrated circuits (ICs), field-programmable gate arrays (FPGAs), and application-specific integrated circuits (ASICs). The marketplace would provide a secure and efficient environment for sellers to showcase their designs while offering buyers access to a diverse catalog of ready-to-use or customizable solutions.

To begin, interested designers 810 must create an account and verify their credentials, ensuring they have the legal rights to sell or license the chip design as part of a registration and listing process. Once approved, sellers can list their designs 820, providing detailed specifications, performance benchmarks, design files, and any associated documentation. They must also specify the terms of sale, such as outright purchase, exclusive or non-exclusive licensing, or royalty-based agreements. The marketplace may offer a template for standard agreements, ensuring clarity on intellectual property rights and usage restrictions.

Buyers 830 can browse listings using filters such as chip type, processing power, energy efficiency, and industry applications as part of a buyer discovery and evaluation process. Each listing includes a description, pricing options, and licensing terms. To evaluate a design, buyers may request additional technical documentation, simulation results, or even a limited-access test version before committing to a purchase. Some platforms may provide a secure virtual environment where buyers can test the design's performance without full access to proprietary details.

Once a buyer expresses interest, the marketplace facilitates communication through a secure messaging or negotiation portal as part of the negotiation and agreement finalization process. Buyers and sellers can discuss customization requests, licensing fees, or bulk purchase discounts. If both parties agree on the terms, they proceed to finalize a digital contract, which may be customized or use a pre-approved template provided by the marketplace. Smart contracts utilizing blockchain technology could also be implemented to ensure transparency and automate royalty payments.

After electronically signing the agreement, the buyer may submit payment through the marketplace's secure payment gateway, which may support various options, including credit cards, wire transfers, and cryptocurrency as part of a Payment and Secure File Transfer or access process. Escrow services may be available to hold funds until the buyer confirms receipt and verification of the design files. Once payment is secured, the seller uploads the chip design files, including layouts, source code, and manufacturing process details. These files are then made available for download under the agreed-upon terms.

Depending on the licensing agreement, sellers may be required to offer post-sale support, assisting buyers with implementation or integration as part of the post-sale support and compliance process. The marketplace may include a built-in support ticketing system to facilitate communication. Additionally, compliance verification ensures that buyers adhere to licensing terms, particularly in royalty-based agreements. Automated tracking mechanisms could monitor usage, ensuring compliance and preventing unauthorized distribution.

To protect both parties, the marketplace may have a dispute resolution mechanism, allowing buyers to raise concerns about incomplete or non-functional designs as part of a dispute resolution and legal protection process. Mediation services may be available, with third-party experts assessing the claims. The marketplace could also enforce penalties for breaches of agreement, ensuring a fair and trustworthy ecosystem.

By integrating these steps, the online marketplace creates an efficient, secure, and legally compliant environment where chip designers can monetize their innovations while providing buyers with high-quality, pre-validated solutions for their semiconductor needs.

### Information Processing System

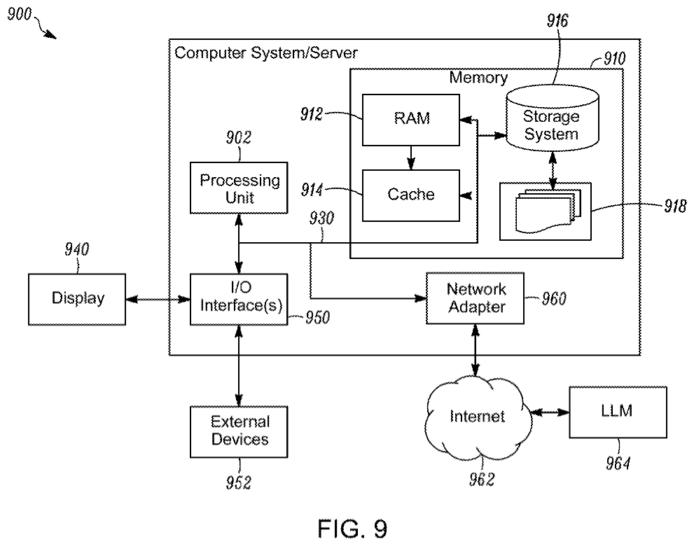

FIG. 9 is a block diagram of an example of an electronic device 900 that may carry out the embodiments of FIG. 2 through FIG. 8 above. The components can include, but are not limited to, one or more processors 902 or processing units, a system memory 910, and a bus 930 that couples various system components, including the system memory, to the processor.

The main memory may include an error identifier, a user interface, user credit reports, a dispute generator, and various error reports. One or more of these components can reside within the processor or be a separate hardware component. The system memory can also include computer system readable media in the form of volatile memory, such as random access memory (RAM) 912 and/or cache memory 914. The error auditing and dispute system can further include other removable/non-removable, volatile/non-volatile computer system storage media. By way of example only, a storage system can be provided for reading from and writing to a non-removable or removable, non-volatile media such as one or more solid state disks and/or magnetic media (typically called a “hard drive”) 916. A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to the bus 930 by one or more I/O interfaces 950 to external device(s) 952. The system memory 910 can include at least one program product having a set of program modules that are configured to carry out the functions of an embodiment of the present disclosure.

Embodiments of the present invention may have a set of program modules stored in memory by way of example, and not limitation, as well as an operating system, one or more application programs, other program modules, and program data. Each of the operating systems, one or more application programs, other program modules, and program data, or some combination thereof, may include an implementation of a networking environment. Program modules 918 generally carry out the functions and/or methodologies of embodiments of the present disclosure.

Embodiments of the present invention can also communicate with one or more external devices such as a keyboard, a pointing device, a display 940, etc.; one or more devices that enable a user to interact with the information processing system; and/or any devices (e.g., network card, modem, etc.) that enable computer system/server to communicate with one or more other computing devices. Such communication can occur via I/O interfaces 950. Still yet, the information processing system can communicate with one or more networks such as a local area network (LAN), a general wide area network (WAN), and/or a public network (e.g., the Internet) 962 via network adapter 960 to LLM 964. As depicted, the network adapter communicates with the other components of the information processing system via the bus. Other hardware and/or software components can also be used in conjunction with the information processing system. Examples include, but are not limited to: microcode, device drivers, redundant processing units, external disk drive arrays, RAID systems, tape drives, and data archival storage systems.

### Non-Limiting Examples

Although specific embodiments of the invention have been discussed, those having ordinary skill in the art will understand that changes can be made to the specific embodiments without departing from the scope of the invention. The scope of the invention is not to be restricted, therefore, to the specific embodiments, and it is intended that the appended claims cover any and all such applications, modifications, and embodiments within the scope of the present invention.

It should be noted that some features of the present invention may be used in one embodiment thereof without the use of other features of the present invention. As such, the foregoing description should be considered as merely illustrative of the principles, teachings, examples, and exemplary embodiments of the present invention, and not a limitation thereof.

Also, these embodiments are only examples of the many advantageous uses of the innovative teachings herein. In general, statements made in the specification of the present application do not necessarily limit any of the various claimed inventions. Moreover, some statements may apply to some inventive features but not to others.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for providing a cloud-based semiconductor design tool, the method comprising:
receiving, from at least one user, via a first interactive graphical user interface (GUI), a design for one or more logic blocks, wherein each of the logic blocks are formed as a corresponding data structure that holds a collection of features specific to that logic block including a hardware description language (HDL) with defined inputs and defined output, and each logic block is stored in a library of logic blocks;
receiving, from the user, via a second interactive GUI, a composite digital design to be synthesized for electrically coupling inputs and outputs from two or more logic blocks, in the library of logic blocks, to each other as defined in the corresponding data structure, to create the composite digital design by performing one of
i. dragging and dropping the two or more logic blocks retrieved from the library,
ii. using a code editor, or
iii. a combination of both;
receiving, from the user, via a third interactive GUI, a simulation to be performed using the corresponding data structure from the composite digital design, wherein the simulation to be performed is from one of a plurality of microservices, including
a simulation microservice configured to execute a digital simulation;
a synthesis microservice configured to perform FPGA or silicon synthesis;
a physical-verification microservice configured to perform design rule checking and layout-versus-schematic validation;
a fabrication packaging microservice configured to generate a foundry-compliant fabrication package;
presenting results of the microservices via a fourth interactive GUI; and
programming a physical hardware device using configuration data derived from the composite digital design.

2. The method of claim 1, wherein the HDL is one of Verilog Code, VHDL, SystemVerilog, and SystemC.

3. The method of claim 1, wherein the design for one or more logic blocks further includes presenting one or more prompts to a generative artificial intelligence module to generate the HDL for at least a portion of one of the logic blocks.

4. The method of claim 1, wherein the simulation to be performed further includes receiving one of using the corresponding data structure from the composite digital design, wherein the simulation to be performed includes receiving one of FPGA synthesis or silicon synthesis.

5. The method of claim 3, further comprising
receiving, from the user, a request to send a process design kit (PDK) based on the corresponding data structure from the composite digital design to one or more foundries to manufacture the composite digital design.

6. The method of claim 3, further comprising
receiving, from the user, a request to perform physical verification to check Layout versus Schematic (LVS), Design Rule Check (DRC), and antenna design.

7. The method of claim 1, wherein the at least one user is a group of users, are each simultaneously interacting with one of
the first interactive GUI,
the second interactive GUI,
the third interactive GUI,
the fourth interactive GUI, or
a combination thereof.

8. The method of claim 1, further comprising:
providing an online marketplace for connecting semiconductor designers with potential buyers
receiving, from a seller, a registration request comprising seller credentials and intellectual property (IP) information;
verifying a seller's legal rights to sell or license the IP based on the seller's credentials; upon successful verification, creating a seller account and enabling the seller to list the IP on an online marketplace platform;
receiving, from a buyer, a search request comprising search criteria related to the IP;
displaying, to the buyer, a list of IP listings matching the search criteria;
facilitating communication between the buyer and the seller through a secure messaging channel;
creating an online contract for automating royalty payments and ensuring transparency; and
holding funds in escrow until the buyer confirms receipt and verification of the IP.

9. The method of claim 8, wherein the providing the online marketplace further includes facilitating transactions of intellectual property (IP) related to integrated circuits (ICs), field-programmable gate arrays (FPGAs), and application-specific integrated circuits (ASICs).

10. A computer-implemented method for analog circuit design, comprising:
receiving, from at least one user, via a first interactive graphical user interface (GUI), a design for one or more analog blocks, wherein each of the analog blocks are formed as a corresponding data structure that holds a collection of features specific to that analog block including a process design kit (PDK) with defined inputs and defined output, and each analog block is stored in a library of analog blocks;
receiving, from the user, via a second interactive GUI, an analog circuit design to be synthesized for electrically coupling inputs and outputs from two or more analog blocks, in the library of analog blocks, to each other as defined in the corresponding data structure to create the analog circuit design by performing dragging and dropping of the two or more analog blocks retrieved from the library;
receiving, from the user, via a third GUI simulating a schematic design using a schematic simulation module with simulation tools and data formats;
modeling fabrication data using the PDK in an analog designer module; and
transmitting fabrication data to a semiconductor foundry.

11. The method of claim 10, wherein the corresponding data structure further comprises at least one of a container name, a description of a container role, a description of a microservice, an identifier of an analog designer, software code, an external system name, or a combination thereof.

12. The method of claim 10, wherein the schematic simulation module comprises at least one of SPICE model, JSON, topology logs, or graphics.

13. The method of claim 10, wherein the analog circuit design to be synthesized further includes defining an overall circuit architecture based on one or more design specifications in a conceptual design phase of an analog chip design flow, wherein the design specifications comprise functional blocks, circuit topologies, and key performance metrics.

14. The method of claim 13, wherein the key performance metrics comprise at least one of gain, bandwidth, power consumption, or noise characteristics.

15. The method of claim 10, wherein the design for the one or more analog blocks further comprising:
designing and optimizing individual circuit elements at a high level in a block creation phase of an analog chip design flow, wherein the individual circuit elements comprise at least one of amplifiers, current mirrors, voltage references, or oscillators.

16. The method of claim 10, wherein the schematic simulation module further comprises:
validating the schematic design through simulation using at least one of SPICE or other circuit simulation tools, wherein the simulation is configured to account for temperature variations and process variations.

17. The method of claim 16, further comprising:
creating test benches to simulate real-world operating conditions and evaluate key parameters to ensure robustness, wherein the key parameters comprise at least one of gain, phase margin, or power dissipation.

18. The method of claim 10, further comprising
physically implementing the analog circuit design on silicon in a layout phase of an analog chip design flow by arranging transistors, resistors, capacitors, and interconnects while adhering to design rules for manufacturability and reliability.

19. The method of claim 18, wherein the analog circuit design to be synthesized further comprises:
performing parasitic extraction to account for real-world effects after the layout phase is completed, wherein the real-world effects comprise at least one of mismatches, parasitic capacitance, or resistance; and
conducting post-layout simulation to ensure the analog circuit design performs as expected despite added parasitic elements.
